(19) United States
(12) Patent Application Publication
(10) Pub. No.: US 2005/0141091 A1
(43) Pub. Date: Jun. 30, 2005

(54) Reflex-type screen

(76) Inventors: Hajime Maruta, Niigata (JP); Norimitsu Ebata, Niigata (JP); Yuji Sawamura, Niigata (JP); Masatoshi Niwa, Niigata (JP)

Correspondence Address: OSHA LIANG L.L.P., 1221 MCKINNEY STREET, SUITE 2800, HOUSTON, TX, 77010, US

(21) Appl. No.: 10/881,295

(22) Filed: Jun. 30, 2004

(30) Foreign Application Priority Data
Dec. 25, 2003 (JP) 2003-430942
Jun. 8, 2004 (JP) 2004-170495

(51) Int. Cl. G02B 5/30

(52) U.S. Cl. 359/488; 359/599

(57) ABSTRACT

The reflex-type screen 10 comprises an aluminum film reflecting layer 20 for reflecting incident light, a lower adhesive layer 18 which is made of adhesive agent, a polarization plate 16 for transmitting the polarized light, a upper adhesive layer 14 which is made of adhesive agent, and a surface diffusion layer 12 with a diffusing agent included inside dispersedly, for transmitting a part of the incident light and diffusing and reflecting anther part of the incident light, and the upper adhesive layer 14 include a diffusing agent 30 dispersedly.

This patent application claims priority from a Japanese patent application No. 2003-430942 filed on Dec. 25, 2003, and Japanese patent application No.2004-170495 filed on Jun. 8, 2004, the contents of which are incorporated herein by reference.

### BACKGROUND OF THE INVENTION

1. Field of the Invention

The present invention relates to a reflex-type screen that reflects polarized light. More particularly, the invention relates to the reflex-type screen for reflecting back a polarized image projected by an optical engine.

2. Description of the Related Art

Conventionally, there is provided a reflex-type screen including a polarization plate and a surface diffusion layer which are stacked in an order on an rolled aluminum film reflecting layer via an adhesive layers. In this reflex-type screen, on the surface of the aluminum film reflecting layer, microscopic liner unevenness is formed, which is called hairline and extends in a direction. The conventional reflex-type screen diffuses and reflects the light by the hairline, thereby improving the view angle of the screen.

The hairline is the surface unevenness, which is generated by rolling, and the diffusion performances of horizontal direction and vertical direction on the screen are different from each other due to the hairline.

In addition, the art of adding a light diffusion ink layer in which a diffusing agent is doped to a light reflecting ink layer is known, in order to improve the diffusion performance of the screen. (Japanese Patent No. 2,953,289)

However, the hair line on the aluminum film reflecting layer is inevitably generated when the aluminum film is formed by rolling, so it is difficult to control the shape of the hair line as desired. Therefore, it is difficult to improve the diffusion performance of the screen by improving the diffusion performance of the aluminum film reflecting layer. In addition, because the art of adding a light diffusion ink layer increases the number of the layers of the screen, there is a problem that the production cost is expensive.

Therefore, it is an object of the present invention to provide a reflex-type screen, which are capable of overcoming the above drawbacks accompanying the conventional art. The above and other objects can be achieved by combinations described in the independent claims. The dependent claims define further advantageous and exemplary combinations of the present invention.

### SUMMARY OF THE INVENTION

To achieve such objects, according to the first aspect of the present invention, a reflex-type screen for reflecting polarized light comprises a reflecting layer for reflecting back incident light, a lower adhesive layer including adhesive material, a polarization plate for transmitting polarized light, an upper adhesive layer including adhesive material; and a surface diffusion layer with a diffusing agent included inside for diffusing and transmitting apart of incident light and for diffusing and reflecting the other part of the incident light in its surface and said reflecting layer, said lower adhesive layer, said polarization plate, said upper adhesive layer and said surface diffusion layer are stacked in this order from opposite side of a light source, and said upper adhesive layer includes a diffusion agent dispersedly

According to the second aspect of the present invention, a reflex-type screen for reflecting polarized light comprises a reflecting layer for reflecting back incident light, a lower adhesive layer including adhesive material, a polarization plate for transmitting polarized light, an upper adhesive layer including adhesive material; and a surface diffusion layer with a diffusing agent included inside dispersedly, for diffusing and transmitting one part of incident light and also diffusing and reflecting the other part of the incident light in its surface and said reflecting layer, said lower adhesive layer, said polarization plate, said upper adhesive layer and said surface diffusion layer are stacked in this order from opposite side of a light source; and said upper adhesive layer includes a diffusion agent dispersedly.

In the second aspect of the present invention, said lower adhesive layer may include said diffusing agent dispersedly.

In both of the first aspect and the second aspect of the present invention, at least one of said upper adhesive layer and said lower adhesive layer may include a light absorption agent dispersedly and absorb a part of transmitted light.

In both of the first aspect and the second aspect of the present invention, the reflex-type screen may further comprise an absorber layer between the surface diffusion layer and the upper adhesive layer, for absorbing a part of transmitted light.

Alternatively, the reflex-type screen may further comprise an absorber layer between the upper adhesive layer and the polarization plate, for absorbing a part of transmitted light.

Alternatively, the reflex-type screen may further comprise an absorber layer between the polarization plate and the lower adhesive layer, for absorbing a part of transmitted light.

Alternatively, the reflex-type screen may further comprise an absorber layer between the lower adhesive layer and the reflecting layer, for absorbing a part of transmitted light.

In both of first aspect and the second aspect of the present invention, the reflecting layer may include unevenness which diffuses light, and the reflex-type screen may further comprise an increase reflecting layer between the lower adhesive layer and the reflecting layer, including a silver thin film layer of which height is lower than that of the unevenness.

Alternatively, the reflex-type screen may further comprise an increase reflecting layer between the lower adhesive layer and the reflecting layer, including a dielectric multiple film which has a low refractive index film and a high refractive index film of which refractive index is higher than that of the low refractive index film, and the low refractive index film and the high refractive index film are stacked alternately, and wherein an equation λ/4=n₁d₁=n₂d₂ is satisfied where a film thickness of the low refractive index film is d₁, a film thickness of the high refractive index film is d₂, a refractive index of the low refractive index film is n₁, a refractive index of the high refractive index film is n₂, and a wavelength of green light (550 nm) is λ.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a cross-section drawing showing a first embodiment of the reflex-type screen 10.

FIG. 2 is a cross-section drawing showing a second embodiment of the reflex-type screen 10.

FIG. 3 is a cross-section drawing showing a third embodiment of the reflex-type screen 10.

FIG. 4 is a cross-section drawings showing a forth embodiment of the reflex-type screen 10.

FIG. 5 is a cross-section drawing showing a fifth embodiment of the reflex-type screen 10.

FIG. 6 is a cross-section drawing showing a sixth embodiment of the reflex-type screen 10.

FIG. 7 is a cross-section drawing showing a seventh embodiment of the reflex-type screen 10.

FIG. 8 is a cross-section drawing showing an eighth embodiment of the reflex-type screen 10.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

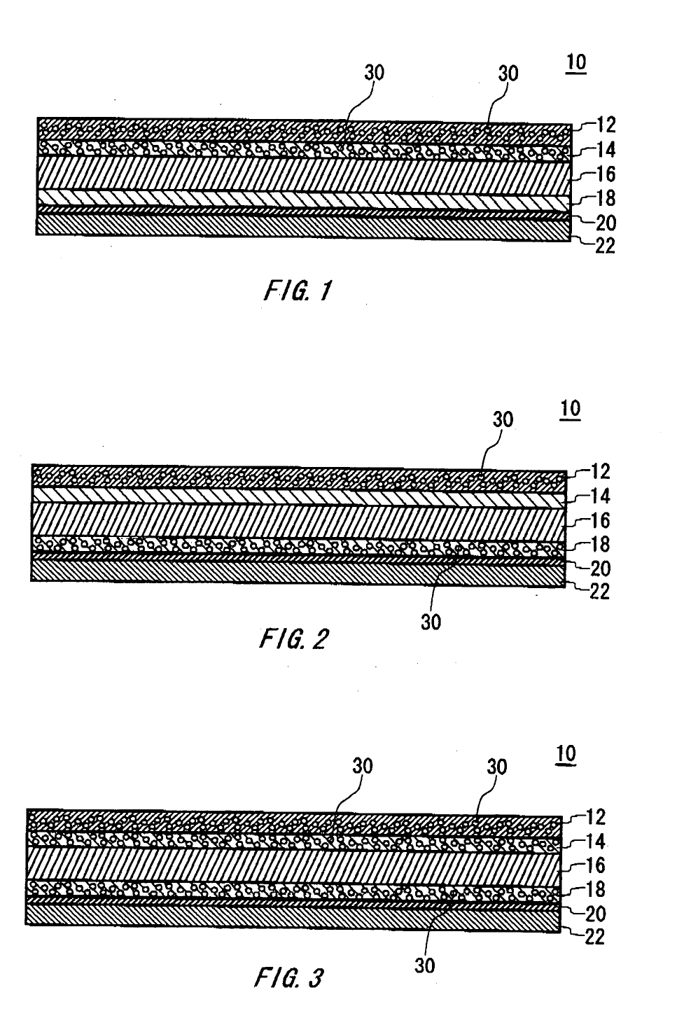

FIGS. 1-3 are cross-section drawings showing basic configuration of the layers with respect to a reflex-type screen 10. The reflex-type screen 10 includes an aluminum film reflecting layer 20, a lower adhesive layer 18, a polarization plate 16, an upper adhesive layer 14, and a surface diffusion layer 12 in this order from opposite side of a light source. The aluminum film reflecting layer 20 reflects incident light. The lower adhesive layer 18 and the upper adhesive layer 14 are made of adhesive agent. The polarization plate 16 transmits polarized light. The surface diffusion layer 12 including diffusing agent 30 diffuses and transmits one part of the incident light and also diffuses and reflects another part of the incident light on its surface.

In a first embodiment shown in FIG. 1, the upper adhesive layer 14 dispersedly includes a diffusing agent 30 internally. Alternatively, in a second embodiment shown in FIG. 2, in place of upper adhesive layer 14, the lower adhesive layer 18 may include the diffusing agent dispersedly. Accordingly, the reflex-type screen 10 can display wide view angle images without making the number of the layers increase in comparison with conventional reflex-type screen.

As a more preferable configuration, like a third embodiment shown in FIG. 3, both of the upper adhesive layer 14 and the lower adhesive layer 18 include the diffusing agent 30 dispersedly. Accordingly, the diffusing agent 30 can be added to both the adhesive layer 14 and 18 so that the diffusing agent 30 is shared in the adhesive layer 14 and the adhesive layer 18. Thus, the quantity of the diffusing agent 30 added to the upper adhesive layer 14 or the quantity of the diffusion agent 30 added to the lower adhesive layer 18 can be limited to a threshold, above which if the diffusing agent 30 is added, a poor appearance e.g. a streak is generated by cohesion. In other words, it is possible to give a desired diffusion performance to the reflex-type screen 10 without a poor appearance e.g. a streak, by adding the diffusing agent 30 to both the upper adhesive layer 14 and the lower adhesive layer 18.

In addition, the lower adhesive layer 18 has a content of the diffusing agent 30 so that the polarized light axis of the polarized light, which passes through the lower adhesive layer 18, does not change. On the other hand, the content of diffusing agent 30 of the upper adhesive layer 14 is higher than that of the lower adhesive layer 18. Thus, a wide view angle can be acquired without decreasing the transmittance of the polarized image projected by a projector.

For example, the surface diffusion layer 12 is a transparent resin film including the diffusing agent 30. As a resin film, TAC (tri-cellulose acetate), polypropylene, vinyl chloride, acryl, or a polycarbonate into which the diffusing agent 30 is kneaded, can be employed. For example, the thickness of the surface diffusion layer 12 is about 80 μm. In addition, the surface of the surface diffusion layer 12 is given the surface hardness and anti-glare effect by the anti-glare processing such as embossed processing or coating processing. In this embodiment, the anti-glare coating agent such as an acrylic binder doped with silica filler is coated to the TAC into which the diffusing agent 30 is kneaded, so as to produce the surface diffusion layer 12. In addition, in this embodiment, the haze value of the surface diffusion layer 12 is about 60.

A pressure sensitive type acrylic adhesive agent is employed as the upper adhesive layer 14 and lower adhesive layer 18. As an adhesive agent, a high transparent adhesive agent, for example an acrylic adhesive agent or a urethane adhesive agent or polyester adhesive agent, can be employed. The thickness of each of the upper adhesive layer 14 and the lower adhesive layer 18 is preferably about 30 μm.

A dye polarization plate can be employed as the polarization plate 16. As the polarization plate, the polarization degree is preferably equal to or greater than 90%. In this embodiment, an iodic polarization plate is used, of which polarization degree is 95% and, thickness is 120 μm. The polarization plate 16 gives a facility of polarization screen to reflex-type screen 10. In other words, the reflex-type screen 10 cuts off about half of the outside light and transmits about 100% of the polarized light from the projector. Thus, the contrast under condition of a bright room can be improved.

An aluminum film, of which the thickness is equal to or less than 0.15 mm and which is made of ingot or slab by a roller, is employed as the aluminum film reflecting layer 20. Specifically, a soft aluminum film 0.007 mm thick is employed. In addition, aluminum film reflecting layer 20 improves processability (affix processability) by attaching the aluminum film reflecting layer 20 to a base material 22 at the opposite side of the light source. A flexible resin film, e.g., a PET film 50 μm thick, is used as the base material 22.

The diffusing agent 30 is added to at least one of the upper adhesive layer 14 and the lower adhesive layer 18 and is also added to the surface diffusion layer 12. In this embodiment, as the diffusing agent 30, a high transparent filler having spherical shape or indeterminate shape, made of silicone, styrene, or acryl can be used. Specifically, spherical silicone beads with 5 μm of the average particle size are employed.

The upper adhesive layer 14 and the lower adhesive layer 18 in which the diffusing agent 30 is dispersed are formed as follows. At first, the transparent diffusing agent 30 such as silicone, silica, styrene or acryl and diluents are kneaded with a transparent adhesive agent such as acrylic adhesive agent so as to produce the diffusion adhesive agent. This diffusion adhesive agent is coated on the surface of the aluminum film reflecting layer 20 and polarization plate 16 using a coating process such as a comma method.

The diffusion performance of the refracting screen 10 is improved and the view angle becomes wider by adding the diffusing agent 30 to at least one of the surface diffusion layer 12, the upper adhesive layer 14, and the lower adhesive layer 14. However, since improvement of the diffusion performance decreases the peak gain, it is preferable that each proper quantities of the diffusing agent 30 is experimentally determined in accordance with both the view angle and peak characteristic which required for the reflex-type screen 10. In addition, there is an upper limitation on processing of the quantity of the addition of the diffusion agent 30 added to both the upper adhesive layer 14 and the lower adhesive layer 18. For example, the addition of the diffusing agent 30 is limited to about 1.5 weight percent when the weight percent of the acrylic adhesive agent (base agent) is 100. If the quantity of the addition is over the limitation, the processability, i.e. the coat processability decreases.

In addition, the quantity of each of the diffusing agent 30 added to the surface diffusion layer 12, the upper adhesive layer 14 and the lower adhesive layer 18 should be within a threshold. If the diffusing agent 30 is added over the threshold, a poor appearance e.g. a streak will be generated by cohesion. The quantity of the addition can be determined by the haze value of each layer of the upper adhesive layer 14 and the lower adhesive layer 18, respectively. For example, it is experimentally verified that the poor appearance, e.g. a streak, by cohesion of the diffusing agent 30 is not generated when the haze vales of each of the upper adhesive layer 14 and the lower adhesive layer 18 is less than 80, more preferably, when it is equal to or less than 70.

In addition, the haze value of each of the surface diffusion layer 12, the upper adhesive layer 14 and the lower adhesive layer 18 is not necessarily equal to one another like the examples as described below. In other words, any combination of the addition of the diffusing agent 30 to the surface diffusion layer 12, the upper adhesive layer 14 and the lower adhesive layer 18 can be used unless poor appearance, e.g. a streak, by cohesion of the diffusing agent 30 is not generated in each of the layers. It is obvious that the diffusion performance of the reflex-type screen 10 is improved when the combination of the quantity of the addition with respect to the surface diffusion layer 12, the upper adhesive layer 14 and the lower adhesive layer 18 is any combination.

The relationship among the particle size of the diffusing agent 30, the diffusion performance of the surface diffusion layer 12, the diffusion performance of the upper adhesive layer 14, and the diffusion performance of the lower adhesive layer 18 will be described as below. When the refractive index of each of the diffusing agent 30, the binder of the surface diffusion layer 12, the binder of the upper adhesive layer 14, and when the binder of the lower adhesive layer 18 is adjusted to the same value, and when the weight percent of each additions is constant, the smaller the particle size of the diffusing agent 30 is, the larger the diffusion performance of each of the surface diffusion layer 12, the upper adhesive layer 14 and the lower adhesive layer 18 becomes. In other words, the haze value of each of the surface diffusion layer 12, the upper adhesive layer 14 and the lower adhesive layer 18 increases, thereby, the diffusion performance of the reflex-type screen 10 is improved. The range of the average particle size is from 1 to 20 μm, preferably about 5 μm. As the particle size becomes larger, the coating processability of each of the upper adhesive layer 14 and the lower adhesive layer 18 decreases. Since thickness of each of the upper adhesive layer 14 and the lower adhesive layer 18 is about from 25 to 35 μm, and since the thickness of the surface diffusion layer 12 is about 80 μm, for example, it is necessary that the particle size of the diffusing agent 30 is adequately less than the thickness.

On the other hand, the relationship among the refractive index of the diffusing agent 30, the diffusion performance of the surface diffusion layer 12, the diffusion performance of the upper adhesive layer 14, and the diffusion performance of the lower adhesive layer 18 will be described as below. When the particle size of the diffusing agent 30 is constant and when the weight percent of each of the addition is constant, the larger the difference of the refractive index between the diffusing agent 30 and the binder of the surface diffusion layer 12, or the difference of the refractive index between the diffusing agent 30 and the binder of the upper adhesive layer 14, or the difference of the refractive index between the diffusing agent 30 and the binder of the lower adhesive layer 18 is, the larger the diffusion performance of each of the surface diffusion layer 12, the upper adhesive layer 14 and the lower adhesive layer 18 becomes larger becomes. In other words, the haze value of each layers become high, thereby, the diffusion performance of the reflex-type screen 10 is improved. In addition, the refractive index of the diffusing agent 30 is about from 1.4 to 1.6. For example, the refractive index of the silicone filler that is used as the diffusing agent 30 is 1.42 and the refractive index of the acryl adhesive agent that is used as the binder is from 1.47 to 1.49.

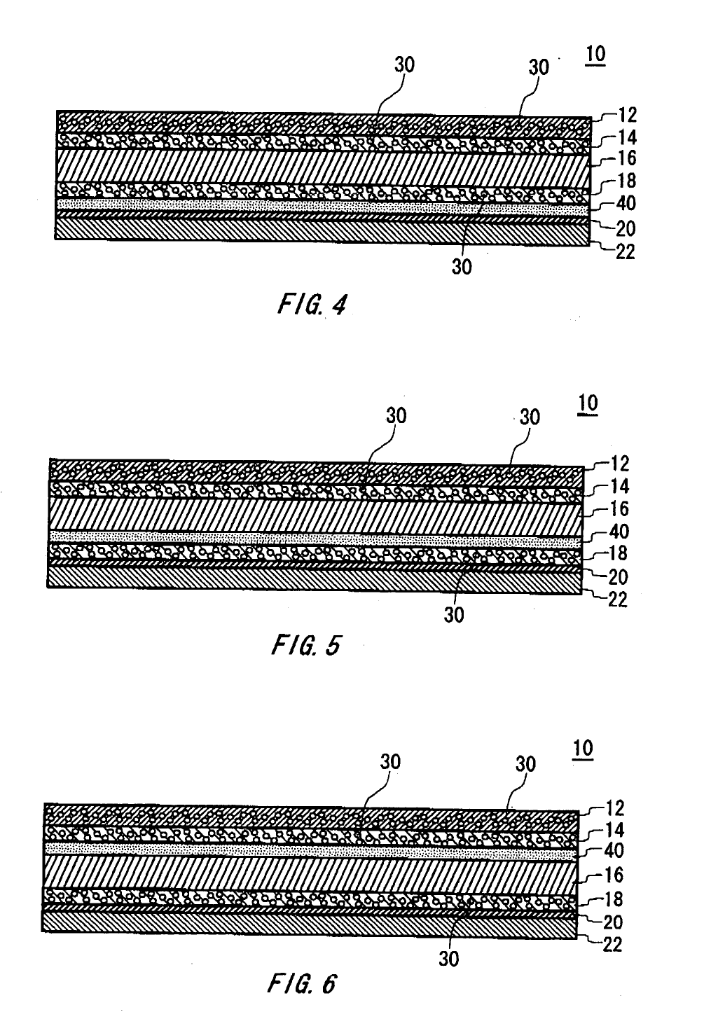

FIGS. 4-8 show additional embodiments in which the optical function layers are added to improve the optical properties of the reflex-type screen 10. FIGS. 4-7 show embodiments, in which an absorber layer 40 is added to absorb a part of the light transmitted through a part of the layers configuring the reflex-type screen 10. FIG. 8 shows an embodiment, in which the increasing reflecting layer 50 is added to improve the reflectivity of the aluminum film reflecting layer 20. Here, the embodiments in FIGS. 4-8 show embodiments in which both the upper adhesive layer 14 and the lower adhesive layer 18 include diffusing agent 30, an embodiment of the present invention is not limited to these embodiments, i.e. either the upper adhesive layer 14 or the lower adhesive layer 18 may include the diffusing agent 30.

The reflex-type screen 10 shown in FIG. 4 includes an absorber layer 40 between aluminum film reflecting layer 20 and the lower adhesive layer 18.The absorber layer 40 includes a light absorption agent, which is made of black dye or black pigment, with adhesive agent or glue, and the absorber layer 40 is provided on the surface of the aluminum film reflecting layer 20 by coating processing. It is preferable that the black pigment is used as the light absorption agent because the black pigment is superior to the black dye with respect to the light stability. The absorber layer 40 has a visible light transmittance about from 50% to 80%. The absorber layer 40 absorbs outside light such as the light of lamps, or stray light such as the multiple reflection light reflected in the screen, the refore, the absorber layer 40 can improve the contrast of an image in visual sense. The principle according to which the absorber layer 40 improves the contrast in visual sense will be described herein after.

The absorber layer 40 absorbs not only outside light and stray light but also white image and black image projected directly from the projector so that the absorbed light intensity is equal to the intensity of (100-transmittance (%))%. In this case, humans feel that the contrast of the image increases because of the characteristic of their eyes. For example, if the brightness of the white image is 50, the brightness of black image is 5, and the transmittance of the absorber layer 40 is 50%, after the light of the images transmit the absorber layer 40, then the brightness of the white image becomes 50 and the brightness of the black image becomes 5. Here, it is known that the quantity of the human sense can be expressed in logarithm function corresponding to physical quantity. This is known as Weber-Fechner Rule, it is S (sense quantity)=Log P (physical quantity)+C. Here, if C is assumed to be zero and the physical quantities described above are substituted, and if the physical quantities are 100 (the white image) and 10 (the black image), the sense quantities are derived to be 1 (the black image) and 2 (white image). Therefore, the contrast in sense quantity is expressed 2:1. On the other hand, if the physical quantities are 50 (the white image) and 5 (the black image), the sense quantities are derived to be 1.7 (black image) and 0.7 (white image). In this case, the contrast in sense quantity is expressed 1.7:0.7=2.4:1. In other words, the image, of which contrast in sense quantity, is expressed 2:1 is improved to 2.4:1 because of the function of the absorber layer 40.

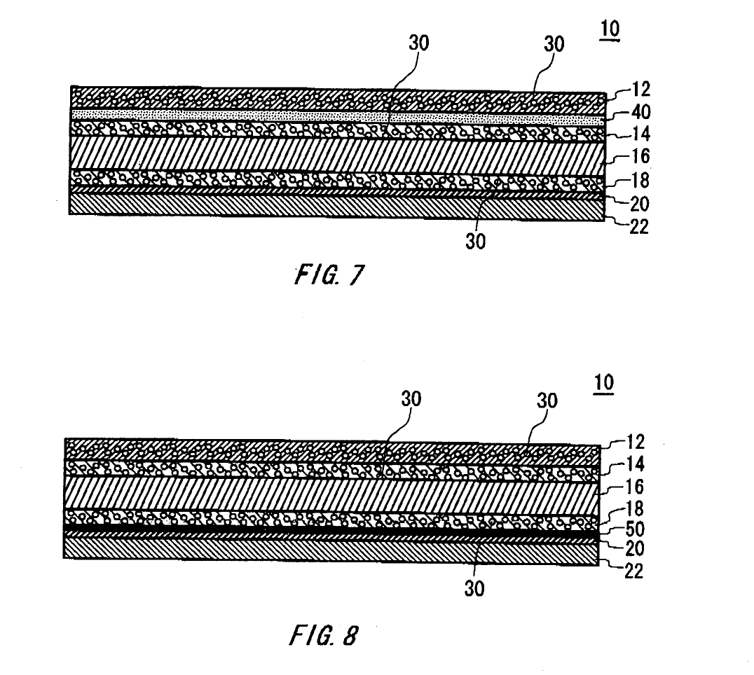

The absorber layer 40 may be placed between the polarization plate 16 and the lower adhesive layer 18 as shown in FIG. 5. The absorber layer 40 may be placed between the upper adhesive layer 14 and the polarization plate 16 as shown in FIG. 6. Alternatively, the absorber layer 40 may be placed between the surface diffusion layer 12 and the upper adhesive layer 14 as shown in FIG. 7. Whenever the absorber layer 40 is placed in any place as shown in FIGS. 5-7, the same effects can be produced.

Alternatively, instead of placing the absorber layer 40 shown in FIGS. 4-7, the light absorption agent may be dispersed at least one part of upper adhesive layer 14 and the lower adhesive layer 18, so that the absorption agent absorbs a part of the transmitted light. In this case, it is preferable that the light absorption agent is added to the upper adhesive layer 14 or the lower adhesive layer 18 so that the visible light transmittances of the upper adhesive layer 14 or the visible light transmittances of the lower adhesive layer 18 is about from 50% to 80%. As described above, the light absorption agent is dispersed at least one of upper adhesive layer 14 and the lower adhesive layer 18, to absorb a part of the light transmitting, thereby the same effect as the absorber layer 40 shown in FIGS. 4-7, i.e., the effect of improving the contrast of the reflex-type screen 10 in visible sense, can be obtained.

FIG. 8 is a cross-section drawing showing an eighth embodiment of the reflex-type screen 10. In this embodiment, the reflex-type screen 10 further includes an increase reflecting layer 50 between the aluminum film reflecting layer 20 and the lower adhesive layer 18, of which thickness is thinner than the height of the unevenness on the aluminum film reflecting layer 20 generated like hairline. The increase reflecting layer 50 increases the reflectivity without disturbing the light diffusion effect of the unevenness generated like hairline on the aluminum film reflecting layer 20. The increase reflecting layer 50 is for example, silver thin film layer. For production method of the silver thin film layer, the silver thin film having about 1000 Å thickness is formed in sputter method or evaporation method on the aluminum film reflecting layer 20. The reflectivity of silver is about 10% higher than that of aluminum. An experimental result shows that the screen gain of the reflex-type screen 10 was improved by about 20%. A transparent resin including urethane may coat the surface of the silver thin film. By this, air exposure and corrosion of the silver thin film can be prevented.

In addition, the increase reflecting layer 50 may be a dielectric multiple film. The dielectric multiple film includes a low refractive index film and a high refractive index film of which refractive index is higher than the low refractive index film and they are stacked alternately. The equation λ/4=n₁d₁=n₂d₂ is satisfied, where the film thickness of low refractive index film is d1, the film thickness of high refractive index film is d2, the refractive index of the low refractive index film is n1, the refractive index of the high refractive index film is n2, and the wavelength of green light (550 nm) is λ. Thus, the reflectivity of the image can be increased, and mainly the green light at the center of the wavelength area of the image can be increased. The dielectric films are stacked, for example, by sputter methods on the surface of the aluminum film reflecting layer 20. The layer configuration of the dielectric multiple films has for example, the low refractive index film, the high refractive index film, the low refractive index film, and the high refractive index film in this order. MgF₂ (magnesium fluoride) is an example of the low refractive index film, of which refractive index is 1.38 and CeO₂ (cerium oxide) is an example of the high refractive index film, of which refractive index is 2.2. The film thickness d1 of MgF₂ as an example of the low refractive index film and the film thickness d2 of CeO₂ as an example of the high refractive index film are expressed as follows according to the conditional equation described above.
d₁(MgF₂)=550/4/1.38=99.6 nm
d₂(CeO₂)=550/4/2.2=62.5 nm

In addition, it is possible to obtain an increase reflecting layer having smaller dependency on the incident angle by controlling the film thickness of each layers on the basis of the value of the film thickness which satisfies the conditional expression described above, i.e., the increase reflecting layer having less color drift due to the incident angle can be obtained. According to experiments, when such a dielectric multiple films is placed as the increase reflecting layer 50, the reflectivity of the reflex-type screen 10 is improved by about 10%.

As is apparent from the above-mentioned description, according to the present embodiment, the reflex-type screen 10 for displaying a wide angle image and a bright image can be realized in low cost.

Although the present invention has been described by way of exemplary embodiments, it should be understood that those skilled in the art might make many changes and substitutions without departing from the spirit and the scope of the present invention which is defined only by the appended claims.

1. A reflex-type screen for reflecting polarized light comprising:
a reflecting layer for reflecting back incident light;
a lower adhesive layer including adhesive material;
a polarization plate for transmitting polarized light;
an upper adhesive layer including adhesive material; and
a surface diffusion layer with a diffusing agent included inside for diffusing and transmitting a part of incident light and for diffusing and reflecting the other part of the incident light in its surface;
wherein said reflecting layer, said lower adhesive layer, said polarization plate, said upper adhesive layer and said surface diffusion layer are stacked in this order from opposite side of a light source; and
wherein said upper adhesive layer includes a diffusion agent dispersedly.

2. A reflex-type screen for reflecting polarized light comprising:
a reflecting layer for reflecting back incident light;
a lower adhesive layer including adhesive material;
a polarization plate for transmitting polarized light;
an upper adhesive layer including adhesive material; and
a surface diffusion layer with a diffusing agent included inside dispersedly, for diffusing and transmitting one part of incident light and also diffusing and reflecting the other part of the incident light in its surface;
wherein said reflecting layer, said lower adhesive layer, said polarization plate, said upper adhesive layer and said surface diffusion layer are stacked in this order from opposite side of a light source; and
wherein said upper adhesive layer includes a diffusion agent dispersedly.

3. A reflex-type screen as claimed in claim 2, said lower adhesive layer includes said diffusing agent dispersedly.

4. A reflex-type screen as claimed in claim 1 or 2, wherein at least one of said upper adhesive layer and said lower adhesive layer includes a light absorption agent dispersedly and absorbs a part of transmitted light.

5. A reflex-type screen as claimed in claim 1 or 2, further comprising:
an absorber layer between said surface diffusion layer and said upper adhesive layer, for absorbing a part of transmitted light.

6. A reflex-type screen as claimed in claim 1 or 2, further comprising:
an absorber layer between said upper adhesive layer and said polarization plate, for absorbing a part of transmitted light.

7. A reflex-type screen as claimed in claim 1 or 2, further comprising:
an absorber layer between said polarization plate and said lower adhesive layer, for absorbing a part of transmitted light.

8. A reflex-type screen as claimed in claim 1 or 2, further comprising:
an absorber layer between said lower adhesive layer and said reflecting layer, for absorbing a part of transmitted light.

9. A reflex-type screen as claimed in claim 1 or 2, wherein said reflecting layer includes unevenness which diffuses light, and said reflex-type screen further comprises:
an increase reflecting layer between said lower adhesive layer and said reflecting layer, including a silver thin film layer of which height is lower than that of said unevenness.

10. A reflex-type screen as claimed in claim 1 or 2, further comprising:
an increase reflecting layer between said lower adhesive layer and said reflecting layer, including a dielectric multiple film which has a low refractive index film, of which film thickness is equal to one forth wavelength of green light, and a high refractive index film, of which film thickness is equal to one forth wavelength of green light and of which refractive index is higher than that of said low refractive index film, and said low refractive index film and said high refractive film are stacked alternately, and
wherein an equation λ/4=n₁d₁=n₂d₂ is satisfied where a film thickness of said low refractive index film is d1, a film thickness of said high refractive index film is d₂, a refractive index of said low refractive index film is n₁, a refractive index of said high refractive index film is n₂, and a wavelength of green light (550 nm) is λ.
